(19) United States
(12) Patent Application Publication
(10) Pub. No.: US 2014/0278812 A1
(43) Pub. Date: Sep. 18, 2014

(54) DIAGNOSTICS STORAGE WITHIN A MULTI-TENANT DATA CENTER

(71) Applicant: MICROSOFT CORPORATION, REDMOND, WA (US)

(72) Inventors: DAVID REINHOLD, SAMMAMISH, WA (US); TAO WANG, BELLEVUE, WA (US); SHENG PENG, SAMMAMISH, WA (US); SRIDHAR SRINIVASAN, SAMMAMISH, WA (US)

(73) Assignee: MICROSOFT CORPORATION, REDMOND, WA (US)

(21) Appl. No.: 13/828,018

(22) Filed: Mar. 14, 2013

(51) Int. Cl. G06Q 10/06

(52) U.S. Cl. CPC G06Q 10/0637
USPC 705/7.36

(57) ABSTRACT

Diagnostic data is received at a multi-tenant data center. The diagnostic data is from a data system instance and the multi-tenant data center hosts data from a plurality of organizations. The diagnostic data is stored at the multi-tenant data center and a rules engine runs on the diagnostic data and provides optimization recommendations for the instance of the data system to which the diagnostic data was collected.

### BACKGROUND

Data systems are currently in wide use. Configuring such systems properly, in order to serve an organization's needs, can be quite difficult. Further, determining whether the data system is configured properly, or could be optimized or otherwise improved, can also be quite difficult.

In one specific example, business data systems are used by many organizations in order to perform business operations. Business data systems can include, for example, enterprise resource planning (ERP) systems, customer resource management (CRM) systems, line-of-business (LOB) systems, and other business data systems.

It is common for business data systems to be purchased by an organization, and implemented by that organization in order to meet the business needs of the organization. However, these types of business data systems can be relatively large and complicated. Therefore, implementing them in the most efficient or effective way, can be difficult. Further, even determining the overall configuration of an implemented business data system (e.g., an instance of the business data system) can be difficult. Therefore, it can be difficult to determine whether the instance of the business data system is configured the best way for the operational needs of the organization.

Multi-tenant data centers are also in relatively wide use. In these types of data centers, the business data (and sometimes even instances of the business data systems) used by a plurality of different tenants are stored and accessed by the tenants. Each tenant corresponds to a separate organization. In this type of architecture, it can be even more difficult to determine whether an on-premise business data system is configured properly, and whether it can be optimized in any way.

The discussion above is merely provided for general background information and is not intended to be used as an aid in determining the scope of the claimed subject matter.

### SUMMARY

Diagnostic data is received at a multi-tenant data center. The diagnostic data is from a data system instance and the multi-tenant data center hosts data from a plurality of organizations. The diagnostic data is stored at the multi-tenant data center and a rules engine runs on the diagnostic data and provides optimization recommendations for the instance of the data system to which the diagnostic data was collected.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIGS. 1 and 1A (collectively FIG. 1) is a block diagram of one illustrative diagnostic architecture in accordance with one embodiment.

FIG. 2 is a flow diagram illustrating one embodiment of the operation of the architecture shown in FIG. 1 in initially discovering a business data system environment.

FIG. 3 is a flow diagram illustrating one embodiment of the operation of a portion of the system shown in FIG. 1 in collecting diagnostic data from an instance of the business data system.

FIGS. 3A-3D show illustrative user interface displays.

FIG. 4 is a flow diagram illustrating one embodiment of the operation of the system in FIG. 1 in evaluating diagnostic data against diagnostic rules.

FIG. 5 is a flow diagram illustrating one embodiment of the operation of the system in FIG. 1 in performing environment discovery in greater detail.

FIG. 6 is a flow diagram illustrating one embodiment of the operation of the system shown in FIG. 1 in performing diagnostic data collection in greater detail.

FIG. 7 is a block diagram of one embodiment of the system shown in FIG. 1 in various architectures.

FIGS. 8-12 show various embodiments of mobile devices.

FIG. 13 is a block diagram of one illustrative computing environment.

### DETAILED DESCRIPTION

FIG. 1 is a block diagram of one embodiment of a diagnostics architecture 100 in accordance with one embodiment. Architecture 100 includes multi-tenant data center (e.g., a host for data for a plurality of tenants using a business data system) 102 coupled to tenants 1-N (104-106). Tenants 1-N indicate that there are a plurality (N) tenants. They will be referred to herein as tenants 104 and 106, but it will be appreciated that more tenants could be hosted by multi-tenant data center 102.

Tenant 104 is shown generating user interface displays 108 with user input mechanisms 110 for interaction by user 112. Tenant 106 is shown generating user interface displays 114 with user input mechanisms 116 for interaction by user 118. Tenants 104 and 106 illustratively access multi-tenant data center 102 over network 120.

User input mechanisms 110 can take a wide variety of different forms. For instance, they can be text boxes, buttons, dropdown menus, icons, links, or other user actuatable input mechanisms for controlling and manipulating tenant 104. In addition, the user input mechanisms 110 can be actuated in a wide variety of different ways. For instance, where the device displaying user interface displays 108 is a touch sensitive screen, mechanisms 110 can be actuated by touch gestures using the user's finger, a stylus, or another mechanism. Similarly, where tenant 104 has speech recognition components, user input mechanisms 110 can be actuated using voice commands. Of course, they can also be actuated using a point and click device (such as a mouse or track ball), a thumb pad, a touch pad, a keypad, hardware or soft keyboard, or another mechanism.

Multi-tenant data center 102 illustratively includes site-wide server and services 122, shared data store 124, one or more processors 126, database servers 128, business data store 130 that holds business data for tenant 104 (including, optionally, diagnostics data 132, and discovery data 133), business data store 134 that stores business data for tenant 106 (as well as, optionally, diagnostics data 137 and discovery data 135), diagnostics engine 136 that has access to diagnostics rules 138, and data viewer component 140.

For the sake of simplicity, the present description will proceed with respect to the data hosted by multi-tenant data center 102 being data for multiple on-premise instances of enterprise resource planning (ERP) systems run at tenants 104-106. It will be appreciated, however, that any type of hosted data center may be implemented using the technologies presented herein, including hosting data for other types of hosted or on-premise business applications (or hosted business data systems).

Site-wide severs and services 122 can illustratively execute various applications and provide site-wide services for multi-tenant data center 102. Database servers 128 illustratively maintain one or more associated databases 130-134.

FIG. 1 shows that, in one embodiment, multi-tenant data center 102 can utilize per-tenant unshared private databases 130-134. Servers 128 can include database servers that execute database functions against databases 130-134. Servers 128 can also include utility servers that perform utility functions, such as reporting services, load balancing, provisioning, configuration, statistics, and other utility functions. When a new tenant is provisioned at multi-tenant data center 102, it can be assigned to one of the groups served by servers 128. One of servers 128 then creates a private, unshared database 130-134 for the new tenant. Association or mapping between the tenant and the assigned group is also created and stored in shared data store 124, along with other configuration information.

Each tenant 104-106 illustratively corresponds to a separate organization. The organizations illustratively want their business data stored in an unshared database 130-134.

Diagnostic engine 136 receives diagnostic data from each tenant (and specifically the environment of a business data system run on the tenant) and runs diagnostic rules against the diagnostic data. This is described in greater detail below.

Processor 126 is illustratively one or more computer processors including associated memory and timing circuitry (not separately shown). It is a functional component of data center 102 and is activated by, and facilitates functionality of, other items of data center 102.

Data viewer component 140 illustratively generates a web interface for viewing data. This is described in more detail below.

FIG. 1 shows that tenant 104 includes one or more database servers 150 that are coupled to an application data store 152. On-premise business application 154 is illustratively a business data system (such as an ERP system, a CRM system, an LOB system, etc.). For purposes of the present description, on-premise business application 154 will be referred to in terms of an ERP application. However, this is for the sake of example only. One or more application servers 156 provide the functionality for on-premise business application 154. Reporting servers 158 can be included to generate on-line analytical processing (OLAP) reporting services. Network servers 168 (which can be embodied as web servers) can access network 120 to upload and download information, and otherwise provide communication, with multi-tenant data center 102. Communication servers 170 control communication between application clients, databases and the applications themselves.

Help servers 172 illustratively provide access to help files for helping user 112 perform various functions at tenant 104. Of course, the on-premise business application environment can include other components, such as other servers, databases, etc., and this is indicated by block 174 in FIG. 1.

FIG. 1 also shows that tenant 104 includes security component 176. Security component 176 illustratively facilitates authentication and secure communication between tenant 104 and multi-tenant data center 102. This is described in greater detail below.

Processor 178 is illustratively a computer processor with associated memory and timing circuitry (not separately shown). It illustratively is a functional part of tenant 104 and facilitates the functionality of various components of tenant 104.

User interface component 180 can be used by various items in tenant 104 to generate user interface displays 108. Of course, component 180 can generate those displays on its own as well.

Environment discovery component 182 can be used to discover the various items that comprise part of the on-premise business application environment on tenant 104. This is also described in greater detail below as well with respect to FIG. 2. Data collection component 184 then collects various configuration and performance data from the components and items that make up the environment of the on-premise business application in tenant 104. Therefore, component 182 discovers the business application environment, and component 184 collects information from the business application environment. Network servers 168 can then provide diagnostic and configuration data 186 back to multi-tenant data center 102. Multi-tenant data center 102 then uses diagnostic engine 136 to run diagnostic rules 138 against diagnostic and configuration data 186. Data viewer component 140 can generate a view of the raw data, evaluation results and recommendations 187 for optimizing or increasing the performance, of the business application environment at tenant 104. User interface component 180 can then display the raw data, the configuration results, and the recommendations 187, on user interface displays 108 for user 112, or they can be viewed by other suitable components.

It will be noted that, while tenant 104 is shown in detail, tenant 106 (and other tenants that use multi-tenant data center 102) may illustratively include similar items to those shown in tenant 104. However, only tenant 104 is shown for the sake of simplicity.

FIG. 2 is a flow diagram illustrating one embodiment of the operation of the architecture 100 shown in FIG. 1 in conducting an initial discovery of the on-premise business application environment at tenant 104. In order to do this, environment discovery component 182 is first downloaded from multi-tenant data center 102 and installed on tenant 104. User 112 first provides authentication information through security component 176 authenticating user 112 as a member of the organization corresponding to tenant 104. For instance, user 112 can generate an on-premise certificate and then sign into a project for which multi-tenant data center provides storage or functionality. User 112 then navigates to an upload page through which user 112 can upload the certificate. It is then uploaded to multi-tenant data center 102. Site-wide servers and services 122 illustratively perform authentication and possibly decryption to ensure that communication between user 112 of tenant 104 and data center 102 is both authorized and secure. Security component 176 can perform security functions on tenant 104, in addition. Receiving the user authentication inputs is indicated by block 200 in FIG. 2, and sending the authentication information to data center 102 is indicated by block 202.

Once secure communication has been authenticated and established, user 112 navigates (under control of site-wide server and services 122) to a download page and downloads and installs the on-premise environment discovery component 182 and data collection component 184. Receiving and installing these components is indicated by block 204 in FIG. 2.

Environment discovery component 182 then conducts an initial discovery of the on-premise business application environment. This is indicated by block 206 in FIG. 2. The discovery process is described in greater detail below with respect to FIG. 5. Briefly, however, environment discovery component 182 is illustratively pointed at database servers 150. Component 182 accesses the other servers enumerated in tenant 104 that are part of the on-premise business application environment. It will be noted that each of the servers are treated separately. For instance, if there are a plurality of application servers 156 serving on-premise business application 154, each of those servers will be treated separately, as a federation of servers instead of as a single server. Thus, the diagnostic and configuration data 186 can be collected on a per-server basis.

In any case, environment discovery component 182 discovers the environment for on-premise business application 154. The environment data, that represents the configuration of the environment, is then sent to multi-tenant data center 102. The discovery data can be stored along with the business data for tenant 104, or it can be stored on a shared data store 124 or elsewhere. In the embodiment shown in FIG. 1, discovery data 133 and discovery data 135 are shown stored separately in the business data store for the individual tenants 104 and 106, respectively. Sending the environment or discovery data to data center 102 is indicated by block 208 in FIG. 2.

FIG. 3 is a flow diagram illustrating one embodiment of the operation of environment discovery component 182 and data collection component 184 in performing a data collection operation. In one embodiment, before performing data collection, certificate-based (or other) authentication is performed to ensure that the data collection is properly authorized. If the authorization fails, the data collection process ends. This is indicated by blocks 207 and 209. In one embodiment, the data collection operation is scheduled. Scheduling the diagnostic data collection can be done in a wide variety of different ways. In one embodiment, user 108 can illustratively open a scheduling application (such as a task scheduler) and create a schedule to run a command line executable. User 112 can identify a diagnostic executable and specify an existing environment by name. User 112 can test the scheduled job by running it manually, through the scheduler, and then inspecting a log file to ensure that it was run properly. The user can then log onto multi-tenant data center 102 and select a project corresponding to the environment for which the data collection has been scheduled. In response, data viewer component 140 generates a dashboard view of that project and also an environmental dashboard for viewing the named environment. The user can examine a log page for the processes corresponding to that environment to confirm that the data collection has been scheduled and that the diagnostic rules 138, corresponding to this diagnostic data collection operation, have been executed.

Therefore, data collection component 184 waits until it is time for a next scheduled diagnostic data collection operation. This is indicated by block 210 in FIG. 3. When it is time to perform a diagnostic data collection, environment discovery component 182 performs a re-discovery operation. That is, even though a discovery operation was originally performed, there may have been updates or modifications to the on-premise business application environment since that original discovery operation. Therefore, component 182 rediscovers the environment. This is indicated by block 212 in FIG. 3.

If there are any environment updates, they are uploaded to multi-tenant data center 102, where they can be stored along with the data for tenant 104. This is indicated by blocks 214 and 216 in FIG. 3.

Data collection component 184 then performs the diagnostic data collection on the re-discovered environment. It should be noted that, when installed, data collection component 184 is agentless. This means that, even if multiple different server instances are being run on multiple different servers on tenant 104, an instance of data collection component 184 is not run on each server. Instead, component 104 looks at that collection of servers as a federation of servers performing together, and collects diagnostic data in this way. One embodiment of some things that data collection component 184 can collect is described in more detail below with respect to FIG. 6. Performing the diagnostic data collection on the re-discovered environment is indicated by block 218 in FIG. 3.

Once the on-premise environmental diagnostic data is collected, security component 176 performs authentication with multi-tenant data center 102. It should be noted that, in one embodiment, the authentication process is performed automatically by security component 176, without any user involvement. However, to the extent user 112 is involved in the communication, then the authentication performed by security component 176 verifies that user 108 is associated with the organization corresponding to tenant 104. In one specific embodiment, the authentication is a certificate-based authentication such as that briefly described above. Performing the authentication is indicated by block 220 in FIG. 3.

Once the diagnostic data has been collected, network server 168 can illustratively upload the diagnostic data 186 to multi-tenant data center 102. It can be stored as diagnostic data 132 in the business data for tenant 130, or in another place. At a suitable time, diagnostic engine 136 can retrieve diagnostic data 132 and evaluate it against the diagnostic rules 138 and return the raw data, the evaluation results and the recommendations 187 to tenant 104. Uploading the diagnostic data to the data center for evaluation is indicated by block 222 in FIG. 3 and receiving the raw diagnostic data, the evaluation results and any recommendations, is indicated by block 224. User interface component 180 can then be used to display the raw data, the evaluation results and the recommendations to user 112 on user interface displays 108. This is indicated by block 226 in FIG. 3.

FIGS. 3A-3D are illustrative user interface displays showing various views that can be selected by user 112 in order to view the information returned by diagnostic engine 136. FIG. 3A shows one embodiment of a user interface display 230. It can be seen that, in user interface display 230, user 112 has selected a dashboard view by actuating dashboard button 232. In response, user interface component 180 shows diagnostic information. User interface display 230 shows that an environment display 234 displays a particular named environment for which the diagnostic data was collected. User interface display 230 also includes a rule message section 236 and a job alert section 238. Rule message section 236 shows a number of servers that had error messages and warning messages generated for them. In addition, a message count indicator 240 shows the number of messages that were generated, by category. For instance, indicator 240 shows that four error messages were generated, one warning message was generated, and no information messages were generated.

Job alert section 238 shows a plurality of different categories of alerts that can be displayed. In one embodiment, the alerts include jobs with unreachable hosts, jobs with errors, and successful jobs. Both sections 236 and 238 illustratively include a graphical indicator, such as a pie chart, which breaks out the messages or alerts, by percentage.

In the embodiment shown in FIG. 3A, user interface display 230 also includes a message list section 242. Message list section 242 shows status, application role, host instance, module, runtime and rule, corresponding to each of a plurality of different messages. In the embodiment shown in FIG. 3A, the last five messages are displayed, although any other desired number of messages could be displayed as well.

FIG. 3B shows a user interface display 244 in which the user has selected the messages button 246. This causes display 244 to show the message list 242 (shown at the bottom of FIG. 3A). It also allows the user to select any of the messages in list 242 and obtain additional information for it. In FIG. 2B, the user has selected a second message 250 from list 242. This causes rule detail section 252 to be updated with the details of the rule that generated the highlighted message 250. In the embodiment shown in FIG. 3B, the rule is “RSCI not configured”. Rule details section 252 includes the name 254 of the rule, along with the module 256 on which the rule was run, and an author 258 of this specific rule. Section 252 also includes a condition indicator 260 that indicates a specific condition that caused the rule to fire. In addition, an observation section 262 provides observations that are relevant to the rule, and recommendation section 264 includes a recommendation to remedy the error or alert that spawned the message. In addition, an additional information section 266 allows user 112 to obtain additional information corresponding to the error or alert that spawned the message.

FIG. 3C shows one embodiment of a user interface display 268. Display 268 is generated when user 112 actuates the environments button 270. This causes one of the components of tenant 104 to display an environments list 272 that lists details about the environment corresponding to on-premise business application 154 in tenant 104. Details section 272 illustratively includes an environment indicator 274 corresponding to the environment, along with a resource type indicator 276, a host name 278 that hosts the environment, an identifier 280 that identifies the environment, and a port number and product version 282 and 284, respectively, corresponding to the displayed environment.

FIG. 3D is one embodiment of a user interface display 286 that is generated when the user actuates the status button 288. It can be seen that user interface display 286 includes a status display 290. Status display 290 again identifies the environment identifier 247 and includes a dropdown menu for selecting a number of status lines that are to be displayed. Display section 290 includes a status display 294, a start time display 296, and a completed time 298. This includes the status of the diagnostic data collection and the start and end times when the diagnostic data collection was started and completed, respectively. In addition, display 290 includes a resource type indicator 300 and a server indicator 302. Indicator 300 identifies the resource type for which the diagnostic data was collected and server indicator 302 indicates the servers for which the diagnostic data was collected.

FIG. 4 is a flow diagram illustrating one embodiment of the operation of diagnostic engine 136 in multi-tenant data center 102 in performing diagnostic services for tenant 104. Multi-tenant data center 102 first receives the certificate-based (or other authentication) information from tenant 104. This is indicated by block 350 in FIG. 4. Diagnostic engine 136 then (after tenant 104 has been authenticated) either receives from tenant 104, or obtains from the data store 130 for tenant 104, the diagnostic data (186 or 132). Receiving or obtaining the diagnostic data is indicated by block 352 in FIG. 4.

Diagnostic engine 136 then accesses diagnostic rules 138 in order to perform the evaluation. It will be noted that rules 138 can be a separate set of rules for each tenant, each business system environment, or they can be one common set of rules, or otherwise. Accessing the rules is indicated by block 354 in FIG. 4.

Diagnostic engine 136 then performs an evaluation of the diagnostic data received for tenant 104 against the diagnostic rules. This is indicated by block 356 in FIG. 4. It will be noted that a wide variety of different types of diagnostic rules can be run against the diagnostic data. The rules can determine whether the servers and environment for the on-premise business application 154 are configured properly or whether they can be configured for improved performance. The diagnostic rules 138 can implement a set of best practices and they can be used to enforce or recommend other things as well. The diagnostic rules 138 can have a wide variety of complexity. For instance, they can expose scalar variables, process records, count the number of files, compare files against one another, implement combinatorial logic against the data, or a wide variety of other things as well. In addition, the rules can be ranked according to importance, or they can be weighted according to importance. The more important rules may generate different types of messages, or the messages generated from those rules can be flagged as being more important than messages generated from other rules, etc.

Diagnostic engine 136 then generates the results of the evaluation, and can also generate recommendations based on those results. This is indicated by blocks 358 and 360 in FIG. 4.

Diagnostic engine 136 and data viewer component 140 can then generate a view of the raw data collected, the evaluation results, and the recommendations, and they can be displayed to a desired user or at a desired location. Generating a view of the raw data collected, the evaluation results and the recommendations 187 is indicated by block 362 in FIG. 4. In one embodiment, the view of this data is provided by a web view generated by data viewer component 140 of multi-tenant data center 102.

FIG. 5 is a flow diagram illustrating one embodiment of the operation of environment discovery component 182 in more detail. In one embodiment, environment discovery component 182 accesses database server 150. The database server 150 illustratively enumerates the various servers and components in the environment of on-premise business application 154. Accessing database server 150 is indicated by block 370 in FIG. 5. Environment discovery component 182 then identifies other servers that are part of the business data system environment (that is, servers on the predefined set of data used by on-premise business application 154). Identifying the other servers on the predefined set of data is indicated by block 372 in FIG. 5.

There are a wide variety of different types of servers that may be identified. For example, they can include the database servers 150, communication server 170, network (or web) servers 168, reporting (e.g., OLAP) servers 158, other types of analytic servers 373, help servers 172, application servers 156, or other servers 374.

Environment discovery component 182 then stores environment data that represents the configuration of the on-premise business application environment. This is indicated by block 376 in FIG. 5.

FIG. 6 is a flow diagram illustrating one embodiment of the operation of data collection component 184 in more detail. Component 184 first illustratively selects an individual server identified in the environment. This is indicated by block 380 in FIG. 6. Next, data collection component 184 collects any of a wide variety of different types of data, for that selected server. This can include, by way of example, running database queries 382, reading registries 384, reading event logs 386, issuing network commands to obtain network statistics 388, or a wide variety of other data collection 390.

It can thus be seen that multi-tenant data center 102 receives diagnostic data from an instance of a business application (such an ERP application). The multi-tenant data center hosts data from a plurality of different organizations. The diagnostics data is stored at the multi-tenant data store and diagnostic engine 136 is run against the collected data to provide evaluation results and optionally a variety of different optimizations or recommendations. The results can be transmitted back to the tenant by a web view from the multi-tenant data center 102 or otherwise. In addition, user 112 is illustratively authenticated to ensure that user 112 is with an organization corresponding to tenant 104. Once the user is verified as being associated with the organization, the diagnostic data associated with the ERP instance for the organization is transmitted to the tenant for viewing by the user 112.

FIG. 7 is a block diagram of architecture 100, shown in FIG. 1, except that it is disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 7, some items are similar to those shown in FIG. 1 and they are similarly numbered. FIG. 7 specifically shows that multi-tenant data center 102 is located in cloud 502 (which can be public, private, or a combination where portions are public while others are private). Therefore, user 112 uses a user device 504 that includes tenant 104 to access those systems through cloud 502.

FIG. 7 also depicts another embodiment of a cloud architecture. FIG. 7 shows that it is also contemplated that some elements of data center 102 are disposed in cloud 502 while others are not. By way of example, data stores 130, 134 can be disposed outside of cloud 502, and accessed through cloud 502. In another embodiment, diagnostic engine 136 and rules 138 are also outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

FIG. 8 is a simplified block diagram of one illustrative embodiment of a handheld or mobile computing device that can be used as a user's or client's hand held device 16, in which the present system (or parts of it) can be deployed. FIGS. 9-12 are examples of handheld or mobile devices.

FIG. 8 provides a general block diagram of the components of a client device 16 that can run components of data center 102 or tenants 104-106 or that interacts with architecture 100, or both. In the device 16, a communications link 13 is provided that allows the handheld device to communicate with other computing devices and under some embodiments provides a channel for receiving information automatically, such as by scanning Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems (like on-premise business application 154) are received on a removable Secure Digital (SD) card that is connected to a SD card interface 15. SD card interface 15 and communication links 13 communicate with a processor 17 (which can also embody processors 126 or 178 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Application 154 or the items in data store 156, for example, can reside in memory 21. Similarly, device 16 can have a client business system 24 which can run various business applications or embody parts or all of tenant 104. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 9 shows one embodiment in which device 16 is a tablet computer 600. In FIG. 9, computer 600 is shown with user interface display 244 (From FIG. 3B) displayed on the display screen 602. Screen 602 can be a touch screen (so touch gestures from a user's finger 604 can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

FIGS. 10 and 11 provide additional examples of devices 16 that can be used, although others can be used as well. In FIG. 10, a feature phone, smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1Xrtt, and Short Message Service (SMS) signals. In some embodiments, phone 45 also includes a Secure Digital (SD) card slot 55 that accepts a SD card 57.

The mobile device of FIG. 11 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

FIG. 12 is similar to FIG. 10 except that the phone is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

FIG. 13 is one embodiment of a computing environment in which architecture 100 (for example) can be deployed. With reference to FIG. 13, an exemplary system for implementing some embodiments includes a general-purpose computing device in the form of a computer 810. Components of computer 810 may include, but are not limited to, a processing unit 820 (which can comprise processor 126 or 178), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 13.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 13 illustrates operating system 834, application programs 835, other program modules 836, and program data 837.

The computer 810 may also include other removable/non-removable volatile/nonvolatile computer storage media. By way of example only, FIG. 13 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 13, provide storage of computer readable instructions, data structures, program modules and other data for the computer 810. In FIG. 13, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 13 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 13 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method, comprising:
receiving diagnostic data, from an instance of a data system, at a multi-tenant data center that hosts data from a plurality of different organizations;
storing the diagnostic data at the multi-tenant data center; and
evaluating rules against the diagnostic data, with an evaluation engine, to generate performance recommendations for the instance of the data system.

2. The computer-implemented method of claim 1 wherein the instance of the data system comprises an instance of a business data system and wherein evaluating rules, comprises:
generating evaluation results by applying the rules to the diagnostic data to obtain evaluation results; and
generating the performance recommendations based on the evaluation results.

3. The computer-implemented method of claim 2 wherein generating the performance recommendations comprises:
generating the performance recommendations as optimizations to the instance of the business data system.

4. The computer-implemented method of claim 2 and further comprising:
generating a web view of the performance recommendations.

5. The computer-implemented method of claim 4 wherein generating the web view includes generating a web view of the diagnostic data and the evaluation results.

6. The computer-implemented method of claim 4 and further comprising transmitting the web view, comprising:
authenticating a user by verifying the user is associated with the given organization; and
in response to verifying that the user is associated with the given organization, transmitting the web view from the multi-tenant data center to the given organization deploying the instance of the business data system.

7. The computer-implemented method of claim 4 and further comprising:
receiving configuration data indicative of a configuration of a business data system environment at the given organization; and
storing the configuration data at the multi-tenant data center.

8. The computer-implemented method of claim 7 wherein receiving configuration data comprises:
receiving data indicative of servers operating on a predefined set of business data corresponding to the instance of the business data system.

9. The computer-implemented method of claim 8 wherein receiving the diagnostic data as data collected from the servers operating on the predefined set of business data corresponding to the instance of the business data system.

10. A multi-tenant data center, comprising:
a plurality of data stores, each data store storing data for a different tenant, each tenant corresponding to a different organization;
a plurality of data servers serving the plurality of data stores; and
a diagnostic engine that obtains diagnostic information from an instance of a data system on a given tenant and evaluates the diagnostic data to obtain evaluation results.

11. The multi-tenant data center of claim 10 wherein the data comprises business data, the data stores comprise business data stores, and the data servers comprise business data servers and the system comprises a business data system, and further comprising:
a data viewer component that generates a view of the evaluation results.

12. The multi-tenant data center of claim 11 wherein the diagnostic engine generates a set of recommendations for the instance of the business data system.

13. The multi-tenant data center of claim 12 wherein the data viewer component generates the view as a web view including the recommendations and the diagnostic data as well as the evaluation results.

14. The multi-tenant data center of claim 13 and further comprising a communication server that authenticates a given user as being associated with an organization corresponding to a given tenant, and in response, transmitting the web view to the given tenant.

15. The multi-tenant data center of claim 11 wherein each business data store stores the diagnostic information for the tenant corresponding to the business data store.

16. The multi-tenant data center of claim 11 wherein each business data store stores environment information indicative of a business data system environment of the tenant corresponding to the business data store.

17. The multi-tenant data center of claim 16 wherein the diagnostic data for a given tenant is generated from the business data system environment of the given tenant.

18. A computer readable storage medium storing computer readable instructions which, when executed by a computer, cause the computer to perform steps comprising:
receiving diagnostic data, from an instance of a data system, at a multi-tenant data center that hosts data from a plurality of different organizations;
storing the diagnostic data at the multi-tenant data center; and
evaluating rules against the diagnostic data, with an evaluation engine, to generate performance recommendations for the instance of the data system.

19. The computer readable storage medium of claim 18 wherein the data system comprises a business data system and wherein evaluating rules, comprises:
generating evaluation results by applying the rules to the diagnostic data to obtain evaluation results; and
generating the performance recommendations as optimizations to the instance of the business data system.

20. The computer readable storage medium of claim 19 and further comprising:
generating a web view of the diagnostic data, the evaluation results and the performance recommendations.
